(19) United States
(12) Patent Application Publication
(10) Pub. No.: US 2005/0138625 A1
(43) Pub. Date: Jun. 23, 2005

(54) Configuration management resource specification database design

(76) Inventors: Timothy J. Carroll, Tampa, FL (US); David G. King, Oakville (CA); Beth A. Stefanchik, Hinsdale, IL (US); Steven M. Weinberger, Lewis Center, OH (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 10/746,710

(22) Filed: Dec. 23, 2003

(51) Int. Cl. G06F 9/46

(52) U.S. Cl. 718/104

(57) ABSTRACT

The present invention provides generalized database tables to implement the classifications of Resource Type, Resource Specification, and Resource Instance, supplemented by individual tables specific to each type of resource, and by the associations and dependencies between them. More specifically, this invention provides database tables comprising a group of structures including Resource Type, Resource Specification and Resource Instance. The Resource Instance is a representation of an individual computing resource, each Resource Instance relates to a physical or logical instance of one Resource Specification. A Resource Specification is a collection of features and functions of a given resource, belonging to one Resource Type which can have zero, one or more resource instances associated with it. A Resource Type, being the highest level of the Resource Model can have zero, one or many resource specifications associated with it.

### BACKGROUND OF THE INVENTION

1. Field of the Invention

This invention generally relates to a framework for resource configuration management database design. The framework provides structures that can be used as the basis for the persistent storage of data required to enable auto-provisioning systems used in the automated allocation and configuration of computing resources.

2. Background Art

Auto-provisioning systems are intended to alleviate operations personnel of the burden of managing specific, individual computing resources. This is accomplished, in part, by providing standard, selectable resource configurations, and standard tools and procedures for managing the types of resources required to support each computing environment. This approach should decrease the cost of infrastructure management and shorten the time needed for delivery of service.

The workflow processing engine at the core of the auto-provisioning system automates the allocation and configuration of individual resources based on the standard resource configurations selected to meet the requirements of each environment. In order to do this, the processing engine requires a database of the standard resource configurations, as well as the specific resource configuration of each environment and the individual resources available for allocation.

The database design required to fully enable an auto-provisioning system must leverage the concept of standard resource configurations in order to gain the intended benefits. Existing products (e.g. Think Dynamics) have incorporated partial solutions. These products provide the ability to implement workflow-based resource allocation and configuration processes, including the allocation and configuration of individual resource instances. In order to address product shortfalls, the base functionality is sometimes supplemented by the ability for the user to create and execute additional workflows and to incorporate user-defined variables in existing workflow processes.

Known solutions do not fully support a comprehensive, auto-provisioning workflow design. They fail to leverage the concept of standard resource configurations, providing resource selection only at the resource instance level. While the ability to incorporate user-defined processes may extend product functionality, the user of user-defined variables lacks the rigor required for data validation and requires repeated entry of common data by the user, with, among other disadvantages, the inherent risk of error.

### SUMMARY OF THE INVENTION

An object of this invention is to support fully a comprehensive, auto-provisioning workflow design for the configuration management of computing resources.

Another object of the invention is to define explicitly a set of classifications, referred to as Resource Type, Resource Specification and Resource Instance, and to use these classifications in the design of databases that enable auto- provisioning systems for configuring computing resources.

In order to achieve these, and other, objectives, the present invention provides generalized database tables to implement the classifications of Resource Type, Resource Specification, and Resource Instance, supplemented by individual tables specific to each type of resource, and by the associations and dependencies between them.

More specifically, this invention provides database tables comprising a group of structures including Resource Type, Resource Specification and Resource Instance. The Resource Instance is a representation of an individual computing resource, each Resource Instance relates to a physical or logical instance of one Resource Specification. A Resource Specification is a collection of features and functions of a given resource, belonging to one Resource Type which can have zero, one or more resource instances associated with it. A Resource Type, being the highest level of the Resource Model can have zero, one or many resource specifications associated with it.

The Resource Instance has, related to it, only that which is required to enumerate specific details about the given instance of a resource. So all instances of a given resource will share a common set of features/functions described in its associated Resource Specification. A Resource Specification with zero instances associated with, it in this model, can still be utilized by a provisioning application in designing request for provisioning. This change in data management allows the provisioning application not only to drive direct provisioning requests but also to drive procurement processes when resources are required but not currently available. In this manner, developing environments can incorporate into their provisioning solution designs all resources which are supported by the provisioning engine, not just the ones which are currently on hand. This allows for added efficiencies in procurement (getting only what you need when you need it) and personal management. For example, architects can design the environment to be provisioned and submit it before resources are ordered, build teams are not cabling physical resources, or working with logical resources which are not currently slated for provisioning, etc.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 shows the hierarchy formed by the Resource Type, the Resource Specification and the Resource Instance.

FIG. 2 illustrates an example of a Resource Type categorization.

FIG. 3 gives an example of a Resource Specification associated with a Resource Type.

FIG. 4 illustrates an extended Resource Model showing Resource Specification sub-types and examples of type interdependencies.

FIG. 5 shows an example of Resource Instance associated with Resource Specification within Resource Type.

FIG. 6 illustrates an Extended Resource Model showing Resource Specification sub-types and association of Resource Instance with Resource Specification.

### DETAILED DESCRIPTION OF THE PREFERRED EMBODIMENTS

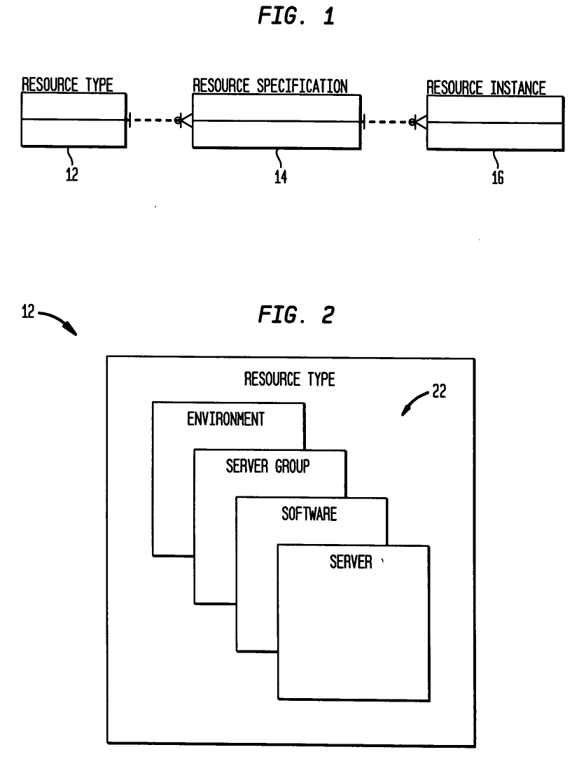

As illustrated in FIG. 1, the categories of Resource Type 12, Resource Specification 14, and Resource Instance 16 form a hierarchy used to represent a computing resource and the categorization of that resource by function and level or capability to deliver functional service.

Resource Type

A Resource Type 12 is a high-level categorization of the set of computing resources supported by the auto-provisioning system. As represented in FIG. 2, this level of categorization is used to organize computing resources into groups 22 of like functions, and may be used to structure the auto-provisioning system and to group the set of workflow processes (i.e., there may be a subset of workflow processes specific to the allocation and configuration of each type of resource).

In the preferred embodiment of this invention, the following resources and categories are considered without excluding other resources and categories of resources defined by skilled personnel in the field:
i) Logical resource types: computing environment, server group, network storage allocation, software package (including both operating system and application packages), IP address;
ii) Physical resources including: switch/routing device, firewall device, load balancer device, server, network interface port, network storage device, switch port; and
iii) Virtual resources: VLAN, virtual machine.
   Resource Specification

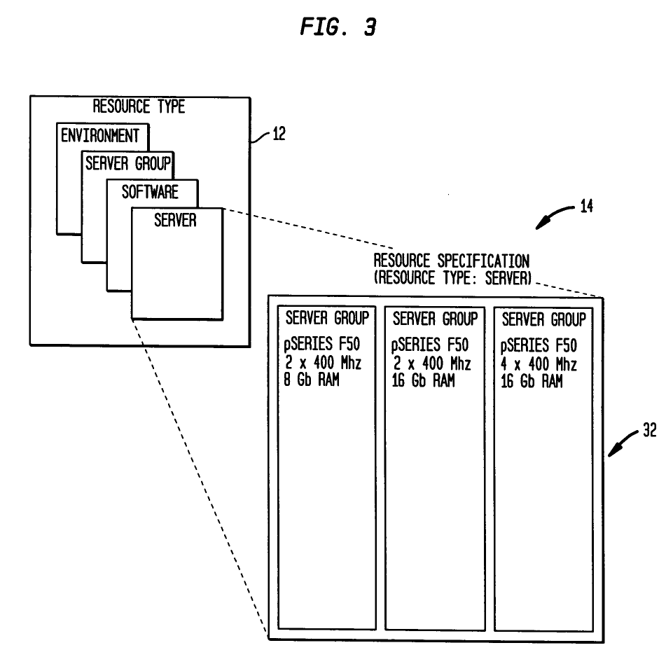

A Resource Specification 14 is a more detailed categorization of the set of computing resources within each Resource Type. This level of categorization, illustrated in FIG. 3, is used to organize computing resources with the same function into logical groups 32 based on the capability to facilitate a given level of functional service.

Each Resource Specification represents a standard configuration of the type of resource, and includes a predefined statement of specific properties relevant to resources of the same type. For example, within the resource type “server” there may be multiple standard configurations based on number of processors, processor speed, memory size, and other properties.

The Resource Specification may also identify specific associations and dependencies on the resource specification of other resource types. For example, within the resource type “software” there may be a dependency on the server configuration required to run the software. This would be represented by a relationship between specific resource specifications of type “server” and the dependent resource specifications of type “software.”

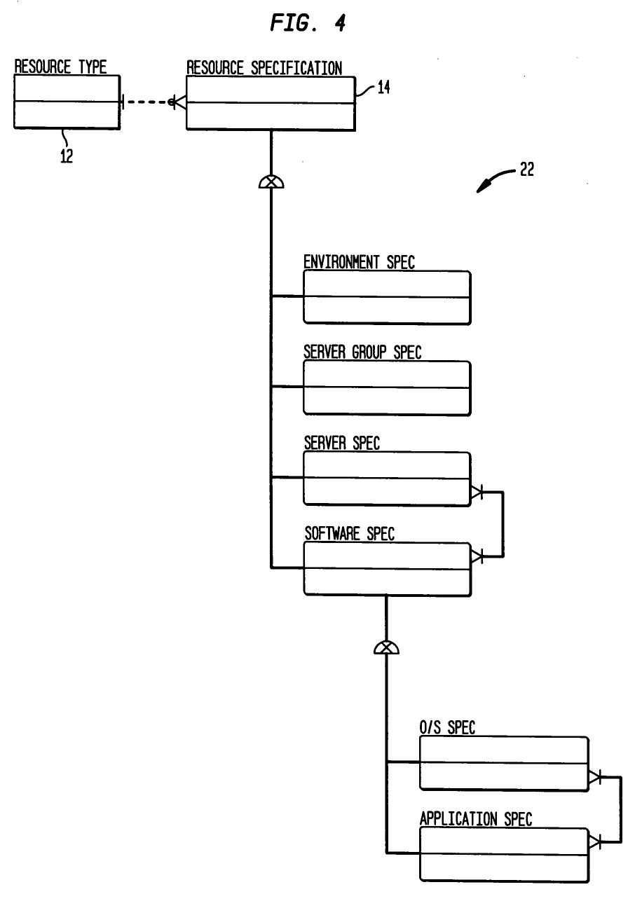

The dependency between resource specification may also be required at a subtype level. For example, software application packages may have a dependency on a specific operating system. With reference to FIG. 4, this may be represented by a relationship between specific resource specifications of type “software—subtype: operating system” and the dependent resource specification of type “software—subtype: application.”

In the preferred embodiment of this invention, this is the level at which the selection of computing resource is specified. The auto-provisioning system user identifies the specification of the required computing resource from the set of selectable resource specifications. The allocation and configuration workflow processes then act at the individual resource (i.e., resource instance) level to satisfy the requirement.

The defined resource specifications are also used to drive the dynamic rendering of the user interface, including:
i) the graphic display of the specific environment being provisioned, and
ii) environment-specific selection lists, where the set of available resources is constrained by the previous selection of related types of resources (e.g., the list of selectable software application packages is limited by the previous selection of the operating system).
   Resource Instance

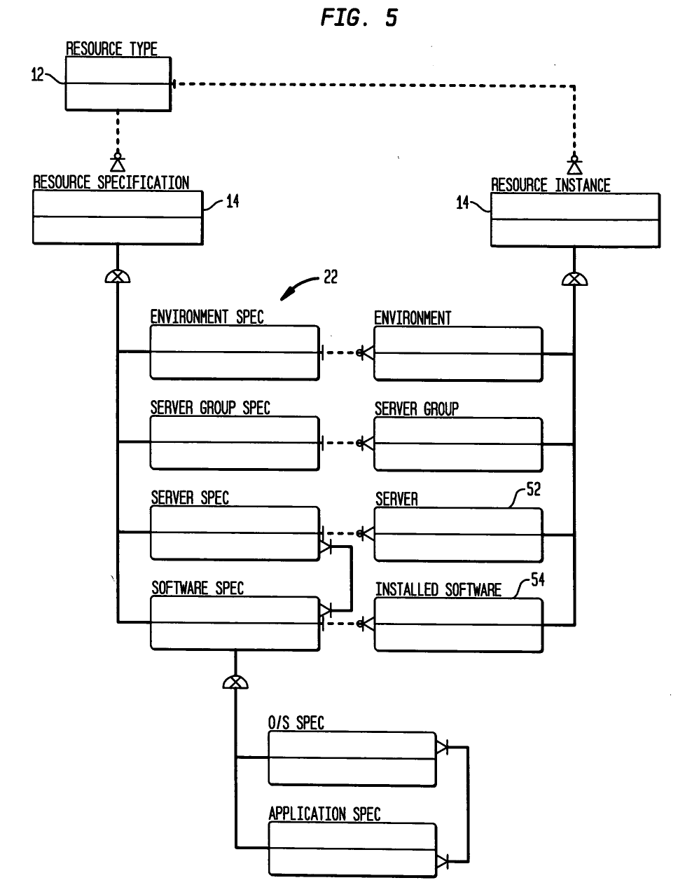

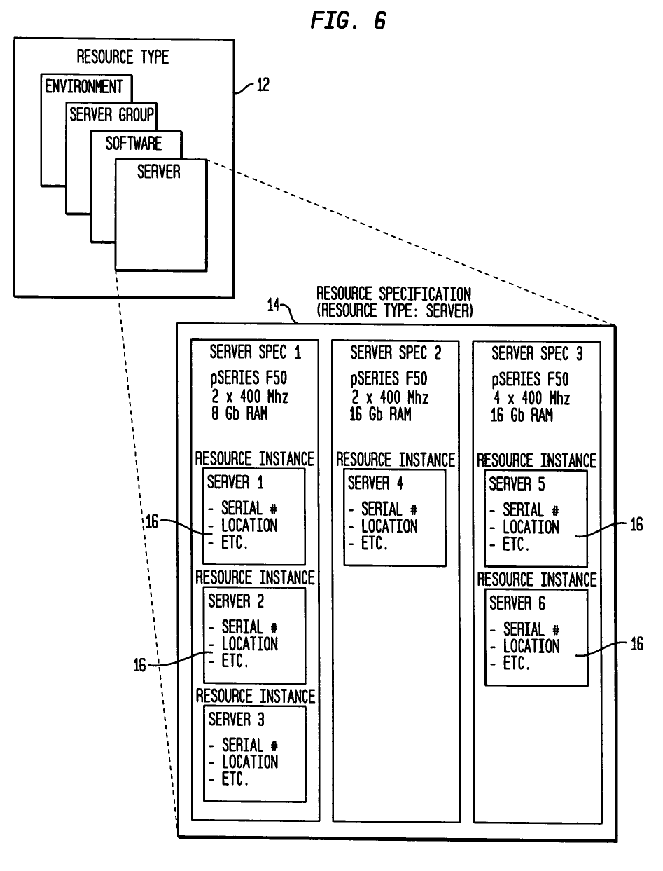

The Resource Instance 16 is a representation of the individual computing resource. With reference to FIGS. 5 and 6, each Resource Instance 16 is categorized by a specific Resource Type to denote functionality, and associated with a specific Resource Specification to denote capability or level of functional service.

For example, a resource instance of type “server” 52 would represent a discrete, computing resource comprising processors, memory, etc. Each resource instance of type “software” 54 would represent the installation of that software package on a server resource, having a given set of specific configuration parameters.

Instances of each resource type are allocated to the environment based on the identification of required resource specifications.

The preferred embodiment of the invention, as described above in detail, provides a number of important advantages. For example, this embodiment of the invention enables the use of standard resource configurations in the allocation and configuration of computing resources, and fully enables automated workflow processing and an interactive user interface, including rigorous data validation. In addition, the preferred embodiment of the invention enables the use of common modules/routines in the capture and management of resource-related data and in the execution of automated workflow processing. Also, this embodiment of the invention enables the dynamic rendering of resource configuration choices to reflect the specific type of environment and resources being provisioned.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A database table comprising:
a group of structures including Resource Type, Resource Specification and Resource Instance;
the Resource Type category identifying a set of computer resource types, each of said resource types including services having like functions; and
wherein each of the computer resource types identified in the Resource Type category includes zero, one or more Resource specifications, each Resource Specification includes zero, one or more Resource Instances, and each Resource Instance is a representation of an individual computing resource; and
wherein the database enables a provisioning application to incorporate into a provisioning solution design, all supported resources, whether or not said supported resources are currently available.

2. A database table according to claim 1, wherein each Resource Specification also identifies specific associations and dependencies on the resource specification of other resource types.

3. A database table according to claim 1, wherein the Resource specification is used to organize computing resources with the same function into logical groups based on the capability to facilitate a given level of functional service.

4. A database table according to claim 1, wherein each Resource Specification represents a standard configuration of the type of resource, and includes a predefined statement of specific properties relevant to resources of the same type.

5. A database table according to claim 1, wherein the Resource Type includes logical resource types, physical resources and virtual resources.

6. A database table according to claim 1, wherein each Resource Instance is associated with a specific Resource Specification to denote capability or level of functional service.

7. A method for implementing a database table design, comprising the steps of:
establishing a group of categories including Resource Type, Resource Specification and Resource Instance; and
identifying in the Resource Type category a set of computer resource types, each of said resource types including services having like functions; and
wherein each of the computer resource types identified in the Resource Type category includes zero, one or more Resource Specification, each Resource Specification includes zero, one or more Resource Instances, and each Resource Instance is a representation of an individual computing resource; and
wherein the database enables a provisioning application to incorporate into a provisioning solution design, all supported resources, whether or not said supported resources are currently available.

8. A method according to claim 7, wherein each Resource Specification also identifies specific associations and dependencies on the resource specification of other resource types.

9. A method according to claim 7, wherein the Resource specification is used to organize computing resources with the same function into logical groups based on the capability to facilitate a given level of functional service.

10. A method according to claim 7, wherein each Resource Specification represents a standard configuration of the type of resource, and includes a predefined statement of specific properties relevant to resources of the same type.

11. A method according to claim 7, wherein the Resource Type includes logical resource types, physical resources and virtual resources.

12. A method according to claim 7, wherein each Resource Instance is associated with a specific Resource Specification to denote capability or level of functional service.

13. A program storage device readable by machine, tangibly embodying a program of instructions executable by the machine to perform method steps for implementing a database table design, said method steps comprising:
establishing a group of categories including Resource Type, Resource Specification and Resource Instance; and
identifying in the Resource Type category a set of computer resource types, each of said resource types including services having like functions; and
wherein each of the computer resource types identified in the Resource Type category includes zero, one or more Resource Specifications, each Resource Specification includes zero, one or more Resource Instances, and each Resource Instance is a representation of an individual computing resource; and
wherein the database enables a provisioning application to incorporate into a provisioning solution design, all supported resources, whether or not said supported resources are currently available.

14. A program storage device according to claim 13, wherein each Resource Specification also identifies specific associations and dependencies on the resource specification of other resource types.

15. A program storage device according to claim 13, wherein the Resource specification is used to organize computing resources with the same function into logical groups based on the capability to facilitate a given level of functional service.

16. A program storage device according to claim 13, wherein each Resource Specification represents a standard configuration of the type of resource, and includes a predefined statement of specific properties relevant to resources of the same type.

17. A program storage device according to claim 13, wherein the Resource Type includes logical resource types, physical resources and virtual resources.

18. A program storage device according to claim 13, wherein each Resource Instance is associated with a specific Resource Specification to denote capability or level of functional service.
